(19) United States
(12) Patent Application Publication
(10) Pub. No.: US 2024/0286376 A1
(43) Pub. Date: Aug. 29, 2024

(54) COMPOSITE PART

(71) Applicant: GIWA GmbH, Westendorf (DE)

(72) Inventors: Daniel Sieberer, Innsbruck (AT); Paul BRAUN, Nordendorf (DE); Christian HELD, Freystadt (DE)

(21) Appl. No.: 18/584,615

(22) Filed: Feb. 22, 2024

(30) Foreign Application Priority Data
Feb. 23, 2023 (EP) 23158175.2

(51) Int. Cl. B32B 3/12; B32B 7/08; B32B 27/08; B32B 27/12; B32B 27/20; B32B 27/40

(52) U.S. Cl. CPC B32B 3/12; B32B 7/08; B32B 27/08; B32B 27/12; B32B 27/20; B32B 27/40; B32B 2305/30; B32B 2307/56

(57) ABSTRACT

A composite part includes a load-bearing plastic part with an outer contour. The outer contour has at least one outer contour area which, in the case of a deformation of the plastic part, can be exposed to a tensile load. At least one mat is arranged at least in the outer contour area, and the mat is connected at least in areas to the outer contour area in a force-transmitting manner and is formed to absorb the tensile load occurring due to the deformation and thus to counteract the deformation of the plastic part.

The present application claims priority to European Patent Application No. 23158175.2, filed on Feb. 23, 2023.

Thus, all of the subject matter of European Patent Application No. 23158175.2 is incorporated herein by reference.

### BACKGROUND OF THE INVENTION

The present invention relates to a composite part, and further to an arrangement with such a composite part and a method for producing such a composite part.

Such composite parts can be used in many different areas of application. For example, they can be used as three-dimensional shapes, such as e.g. seats and furniture in lightweight construction, pallets for logistics applications, formwork, load-bearing or reinforcing elements in the building industry or as floors for vehicle trailers.

Similar parts which can pursue the same intended purposes but are formed homogeneous and/or monolithic inherently and which are therefore not composite parts are shown in the documents JP 2009208279 A and CN 202580582 U. JP 2009208279 A shows a lattice-like load-bearing element consisting of a fiberglass-reinforced plastic (FRP) in the form of a grating, which is used in particular for building structures. CN 202580582 U likewise shows an FRP grating which is used in particular in the vehicle industry.

A disadvantage of the parts named in these documents is that their load-bearing capacity is limited on the one hand by the material parameters and on the other hand by the dimensions.

This means conversely that the load-bearing capacity can be increased and/or the deformation, deflection or warpage can be reduced by means of the material choice and the choice of the dimensions, such as e.g. the component height in the case of a component subjected purely to bending, such as e.g. in the case of a conceptually imagined single-span beam.

However, if it is desired, e.g. for esthetic reasons, to use slim parts and/or, e.g. in the case of a free space available to a limited extent, to increase the load-bearing capacity with the same dimensions and/or to increase the serviceability, such parts quickly hit their limits.

### SUMMARY OF THE INVENTION

The object of the present invention is therefore to provide parts or composite parts that are improved compared with the state of the art and have increased load-bearing capacity and smaller deformations.

This object is achieved by at least one mat being arranged at least in the outer contour area, wherein the at least one mat is connected at least in areas to the outer contour area in a force-transmitting manner and is formed to absorb tensile load occurring due to the deformation and thus to counteract the deformation of the plastic part.

The great advantage of the invention is that the load-bearing capacity of the composite element is many times higher compared with a conventional unmixed part, as used e.g. in the state of the art, with identical dimensions.

Tests by the inventor have shown that the composite part according to the invention is capable of absorbing up to 3 times the load compared with an unmixed part with identical dimensions.

A further advantage is that the deformations are also much smaller as the mat can absorb and transmit many times the tensile loads or stresses within the composite part and thus counteracts a deformation, deflection or warpage of the plastic part. As the composite part deforms, bends or warps much less under load compared with an unmixed part with the same dimensions, the serviceability of the composite part is also much greater, which can be beneficial in particular for load-bearing structures that can be walked and/or driven on.

Much slimmer formations or structures, for example thinner beams, shells, plates, freeforms etc., are also possible with the composite part, which can bring with it e.g. an esthetic advantage in the case of building structures.

Thinner or slimmer components or composite parts moreover bring with them a much lower material cost as material can be saved. In particular, in connection with the use of plastic materials, as in the present case, this is relevant in terms of environmental impact and the use of resources.

Thinner or slimmer formations are furthermore accompanied by a lower self-weight, which can be very beneficial for many applications from a static perspective. Moreover, lighter components are easier to handle.

The load-bearing plastic part of the composite part is to be understood substantially as a rigid component which is substantially elastically and/or relatively slightly or negligibly plastically deformable.

The load-bearing plastic part can in principle have any shape, wherein its outer contour represents the enveloping surface. This means that any openings, recesses, structures of the plastic part are enveloped by the outer contour.

The outer contour area of the outer contour is to be understood as that area of the outer contour and surface of the plastic part which can be exposed to a tensile load or along which area tensile stresses can occur, wherein the tensile stresses can occur due to a deformation of the plastic part caused by means of a load.

The outer contour area of the outer contour can be understood as that area of the outer contour and surface of the plastic part which is exposed to a tensile load or where tensile stresses occur due to a deformation of the plastic part.

Preferably, the at least one mat is arranged solely at the outer contour area. This means that the at least one mat preferably is only arranged and/or connected in areas of the contour of the plastic part where tensile stresses can occur or are present, particularly due to deformation of the plastic part.

Preferably, the at least one mat is arranged solely at the outer contour area, wherein the outer contour area is an area of the plastic part which is located opposite to a force-application surface of the contour of the plastic part.

For instance, if the force-application surface is a top surface of the plastic part, the at least one mat is preferably arranged at the outer contour surface at a bottom surface of the plastic part; and vice versa.

The mat connected at least in areas to the outer contour area is substantially at least one mat, ply, film, e.g. SGP film, or the like which is flexible at least in areas and/or temporarily and the shape of which can be adapted in particular to the outer contour area.

It is conceivable that exactly one mat is connected to the outer contour area, preferably wherein the outer contour area is or can be exposed to tensile stresses.

It is also possible for the mat to be able to be at least partially rigid and/or hard, hardened and/or curable for particular intended purposes.

It is particularly preferable that the outer contour has at least one force-application surface spaced apart from the at least one outer contour area, preferably by a thickness of the plastic part. The plastic part is, in particular substantially elastically, deformable through the action of an external force on the force-application surface.

It is also conceivable that the plastic part is deformable through the action of at least one internal force, such as e.g. a temperature load.

By the thickness of the plastic part can be meant for example a constant and/or average thickness.

In particular, that thickness of the plastic part which defines the bending or warping moment resulting from a prevailing load that can be absorbed is to be understood and/or used and/or relevant as thickness. In the case of a composite part in the form of a conceptually imagined single-span beam, the thickness would be the height of the component, thus that thickness which spaces the force-application surface apart from the outer contour area.

In general, a variable thickness is possible, wherein for example partial jumps in thickness or height, in particular to increase the absorbable force, are conceivable. For example, individual or several ribs or struts can be formed thicker, thinner, longer, shorter, higher or lower than other ribs or struts.

One or more concentrated loads or point loads and/or one or more distributed loads can be applied to the force-application surface.

It is particularly preferable that the plastic part is formed with a strutting and/or ribbing with, in particular regularly arranged, struts and/or ribs and/or is formed in the form of a grating.

The strutting and/or ribbing can be formed for example with struts and/or ribs parallel to each other and/or have a honeycomb structure.

At least in some areas, the plastic part can have a border, preferably a border of a strutting and/or ribbing and/or of a grating, in particular wherein the border can be understood as a delimitation of the plastic part.

It is particularly preferable that the at least one mat is completely connected to the outer contour area of the plastic part in a force-transmitting, in particular tensile-force-transmitting, manner.

The at least one mat can also be connected in a force-transmitting manner only on the border and/or in smaller subareas of the outer contour area.

It is preferable that the force-transmitting connection between the mat and the plastic part be produced in a material-bonding manner, in particular a chemically and/or thermally material-bonding manner, for example by welding, adhesive bonding, vulcanizing, laminating, coating, overmolding and/or by embedding.

It is also conceivable that the force-transmitting connection between the mat and the plastic part be produced at least in some areas in a friction- or non-positive-locking manner and/or in a positive-locking manner.

It is particularly preferable that the plastic part be a shaped part produced by a shaping method, in particular an injection-molding part or continuous-casting profile.

By shaping methods can be meant injection-molding, transfer-molding, spray-foam, pressing or continuous-casting methods and the like.

It is particularly preferable that the plastic part consists at least of at least one thermoplastic, in particular amorphous or partially crystalline, and/or technical and/or biobased plastic.

Recycled material types, e.g. as post-consumer recycled (PCR) material and/or post-industrial recycled (PIR) material, can also be used in application cases.

Furthermore, it is conceivable that the plastic part has a wood portion, i.e. consists of a plastic/wood mixture.

The plastic part can consist at least partially of at least one filler.

Fillers can be e.g. glass fibers, basalt fibers, glass beads, impact modifier, flame retardants, mineral additives, natural fibers, nanomaterial, such as e.g. tungsten powder, etc.

It is preferable that the portion of the total of all fillers is greater than 3%, preferably greater than 8%, particularly preferably greater than 10%, of a total volume and/or a total mass of the plastic part.

It is particularly preferable that the mat consists at least partially of fibers, in particular comprising aramid, glass, carbon and/or basalt fibers.

The fibers can be contained in the mat as loose or individual fibers and/or in the form of at least one woven fabric, non-crimp fabric, or the like.

For example, aramid woven fabric, biaxial glass non-crimp fabric, carbon non-crimp fabric, design woven fabric, fiberglass mats, glass filament woven fabric, hybrid fabric and/or basalt fiber woven fabric are conceivable.

It is preferable that the mat consists at least partially of at least one resin and/or can be connected to and/or cured with a resin, adhesive or the like.

Conceivable options are, in particular, epoxy resin, polyester resin, polyurethane resin, and/or other synthetic resins.

The outer contour of the composite part can have a smooth and/or rough and/or structured surface texture at least in areas.

The surface of the mat and/or of the plastic part can be formed depending on the intended use or application. For example, the mat and/or the plastic part can be formed nonslip by a rubberized and/or rough surface texture.

It is preferable that the plastic part has a substantially plate-shaped outer contour with flat outer contour surfaces, with the result that the plastic part can be used for example as a disk-, plate-, wall- or pallet-like load-bearing and/or supporting device.

In a typical application of the composite part, for example, as a pallet-like load-bearing device, the composite part can be 180 cm long, 60 cm wide and 3 cm thick and/or have struts with a grid spacing of 60 cm in the longitudinal direction.

The plastic part can also have a curved outer contour with at least one curved outer contour surface, with the result that the plastic part can be used for example as a three-dimensional negative mold.

The plastic part can have a substantially constant thickness, wherein at least in each case two of the outer contour surfaces are arranged substantially parallel to each other.

However, the plastic part can also have a variable thickness, wherein for example in areas a larger thickness can be provided in areas of increased load, in order to achieve a greater rigidity of the plastic part in areas for example.

In order to achieve a greater rigidity of the plastic part at least in areas, additional ribs and/or struts can also be provided.

The outer contour can have at least one force-transmitting ply or layer, which is connected at least in areas to the outer contour in a force-transmitting manner.

In particular, the force-transmitting ply can be formed to absorb compressive forces or stresses, wherein the force-transmitting ply can in principle have any shape.

It is conceivable that the force-transmitting ply has a constant thickness and/or is formed solid; however, it can also be hollow at least in areas and/or be formed by struts and/or ribs.

Protection is also sought for an arrangement with at least one bearing point, by which at least one composite part is or can be mounted in a stable balanced state. The composite part can be loaded by an external force and is, in particular substantially elastically, deformable at least in the direction of a force-application direction.

Such an arrangement can also be understood as a possible load case in which the composite part can be mounted in a particular way and can be exposed to a predetermined load.

For example, the plastic part can be mounted on at least one bearing point over the whole surface and/or substantially at points or in areas linearly and/or two-dimensionally, wherein the bearing can be rotationally and/or displaceably fixed or free.

For example, the arrangement can comprise at least two bearing points spaced apart from each other, wherein the at least one composite part can be mounted by the at least two bearing points.

It can be the case that the at least two bearing points are spaced apart from each other by at least one cavity, and wherein the at least one outer contour area of the at least one composite part faces the at least one cavity. This case arises in particular when the composite part, in particular the plastic part, can deform, bend or warp under load in the direction of the cavity, which can be the case for example in a bridge-like, in particular single-span, arrangement.

Furthermore, protection is sought for a method for producing a composite part, characterized by the following method steps:
at least one plastic part is provided, preferably by a shaping process, in particular by injection molding, and at least one mat is provided,
the at least one mat is connected at least in areas to the outer contour area of the plastic part in a force-transmitting manner, in particular in a material-bonding and/or positive-locking manner, in particular by means of welding, adhesive bonding, vulcanizing, laminating, coating, overmolding and/or by means of embedding.

It is particularly preferable that in the course of the named method:
the at least one plastic part is produced by means of a shaping method, in particular an injection-molding method, and/or
at least one resin, in particular epoxy resin, is applied to the mat, in particular by means of laminating.

The mat can be deformable and/or substantially rigid or stiff in an operating state.

### BRIEF DESCRIPTION OF THE DRAWINGS

Further advantages and details of advantageous embodiments of the invention are revealed by the figures and the associated description of the figures, in which:

FIGS. 1-2 show a first embodiment of a composite part,

FIG. 3 show a first embodiment of a plastic part,

FIG. 4 show a second embodiment of a composite part,

FIG. 5 show a third embodiment of a composite part,

FIGS. 6-7 show a possible arrangement with the first embodiment of a composite part, and

FIGS. 8-11 show further possible arrangements with different embodiments of a composite part.

### DETAILED DESCRIPTION OF THE INVENTION

Firstly, it may be stated that all figures are schematic representations without being true to scale. Thus, e.g., the dimensions, in particular the thickness 7 of the plastic part 2 and the thickness of the mat 6, are chosen as desired and therefore also do not correspond to the actual dimensions relative to each other. In some figures the mat 6 is represented merely by a thin layer or line.

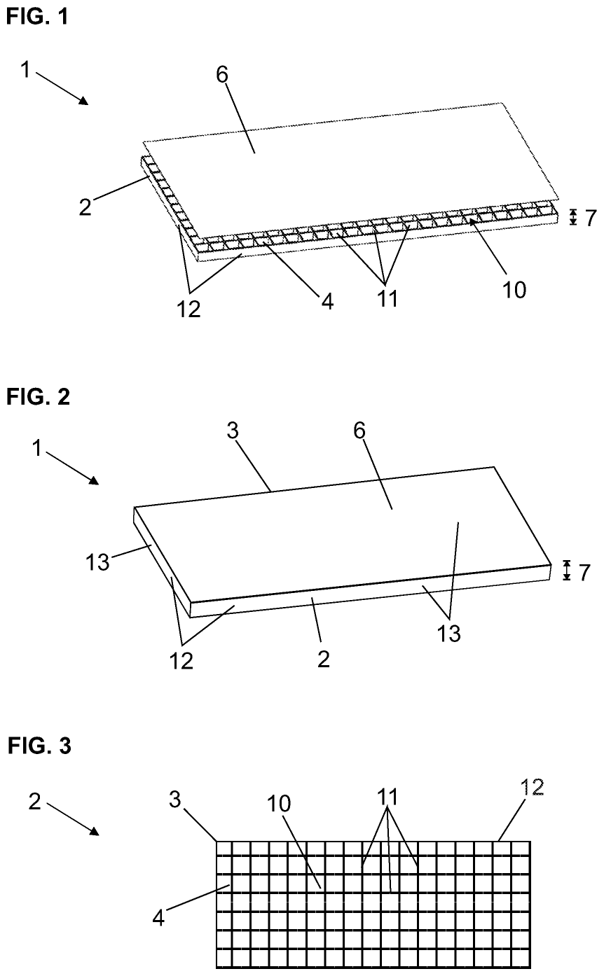

FIGS. 1 and 2 show a first embodiment of a composite part 1 with a load-bearing plastic part 2 with an outer contour 3, wherein the outer contour 3 has at least one outer contour area 4 which, in the case of a deformation 5 of the plastic part 2, can be exposed to a tensile load, in particular tensile stresses occurring locally within the plastic part 2, wherein at least one mat 6 is arranged in the outer contour area 4 and wherein the mat 6 is connected at least in areas to the outer contour area 4 in a force-transmitting manner.

FIG. 1 shows an exploded representation, wherein the plastic part 2 and the mat 6 are represented spaced apart from each other. FIG. 2 shows the composite part 1, wherein the mat 6 is connected to the plastic part 2 in a force-transmitting manner.

In this embodiment the plastic part 2 is formed as a grating with a strutting 10 with regularly arranged struts 11.

In general, however, the plastic part 2 can have any desired shape, wherein solid and/or hollow cross sections, the arrangement of struts and/or ribs, constant and/or variable dimensions, etc. are possible.

In this embodiment the plastic part 2 or the grating has a continuous border 12.

In principle, however, a border 12 is not necessary. The border 12 can also be present only in areas.

In this embodiment the at least one mat 6 is completely connected to the outer contour area 4 of the plastic part 2 in a force-transmitting manner. This means that the mat 6 is connected to the plastic part 2 on at least one of the largest possible outer contour surfaces 13 of the plastic part 2, wherein the area of the connection has a grid-shaped contour.

In principle, however, the at least one mat 6 can also be connected only in areas to the plastic part 2 in a force-transmitting manner.

For example, the mat 6 can be connected to the plastic part 2 in a force-transmitting manner with the border 12 of the plastic part 2.

The mat 6 can also be connected to the plastic part 2 only in a subarea or in several subareas of the outer contour area 4.

The force-transmitting connection between the mat 6 and the plastic part 2 is preferably formed in a material-bonding, in particular chemically and/or thermally material-bonding, manner and/or in a positive-locking and/or non-positive-locking manner, wherein the connection can be produced for example by means of welding, adhesive bonding, vulcanizing, laminating, coating, overmolding and/or by means of embedding.

Regarding the representation in FIGS. 1 and 2, it may be noted that the mat 6 is arranged at the top on the plastic part 2 in this embodiment, thus it can counteract in particular a deformation 5, deflection or warpage upwards and the tensile stresses occurring on the upper side, in particular if the warpage is effected in a central area of the composite part 1. If the composite part 1 is oriented inverted, with the result that the mat 6 is arranged on the underside of the plastic part 2, then the mat 6 would be formed in particular to counteract a deformation 5, deflection or warpage downwards.

In this embodiment the plastic part 2 has a substantially plate-shaped outer contour 3 with flat outer contour surfaces 13, wherein in each case two of the flat outer contour surfaces 13 are arranged substantially parallel to each other.

FIG. 2 shows the first embodiment, shown in FIG. 1, of a composite part 1 in the connected state in which the mat 6 is connected to the plastic part 2. The shown contours of the composite part 1 and/or plastic part 2 correspond to the outer contour 3 of the plastic part 2.

In the descriptions, which follow now, of the embodiments shown in the following figures it is primarily the differences from the first embodiment that are discussed, to avoid repetitions. Otherwise, the above description of the first embodiment also holds, where applicable, for all embodiments yet to be described in the following.

FIG. 3 shows a first embodiment of a plastic part 2 in a top view, wherein the plastic part 2, in a similar way to in the embodiment shown in FIG. 1, has a strutting 10 with regular struts 11, with the result that the plastic part 2 is essentially a grating with a border 12.

The outer contour area 4, with which a mat 6 can be connected at least in areas to the plastic part 2 in a force-transmitting manner, here has a flat grid shape or contour.

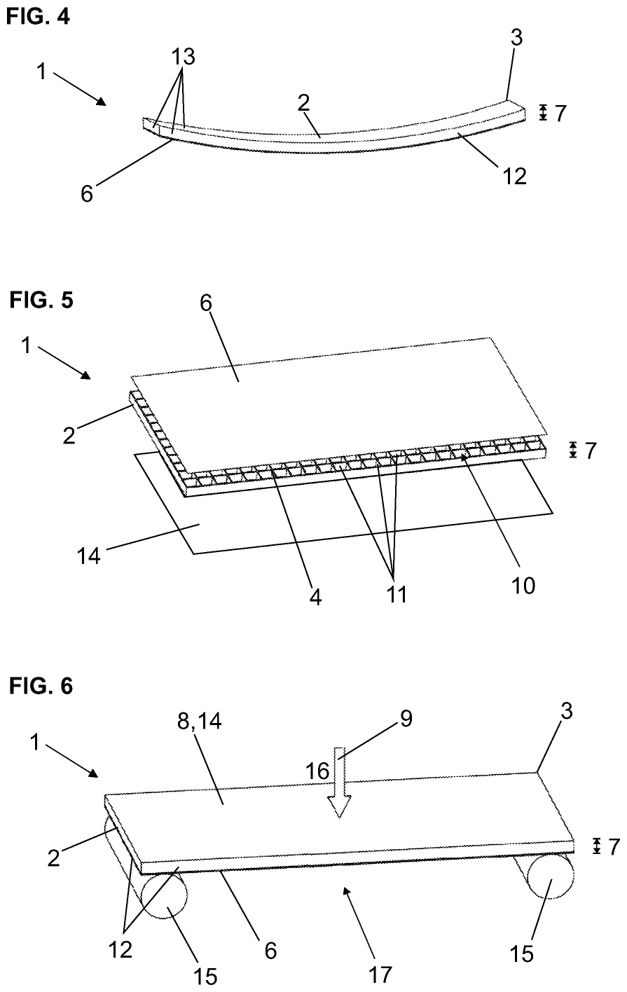

FIG. 4 shows a second embodiment of a composite part 1, in which the plastic part 2 has a curved outer contour 3 with curved outer contour surfaces 13, wherein in each case two of the curved outer contour surfaces 13 are arranged substantially parallel and/or offset relative to each other.

In this representation the mat 6 is arranged on the underside of the plastic part 2, with the result that the mat 6 can counteract any deformation 5 or deflection of the plastic part 2 downwards, in particular if the deformation 5 takes place in a central area of the plastic part 2.

FIG. 5 shows a third embodiment of a composite part 1, in which a force-transmitting ply 14, which is connected at least in areas to the outer contour 3 of the plastic part 2 in a force-transmitting manner, is arranged on one side of the plastic part 2.

The force-transmitting ply 14 is beneficially formed to absorb compressive forces and/or to stiffen the plastic part 2.

In this representation the mat 6 is located on the upper side and the force-transmitting ply 14 is located on the underside of the plastic part 2, with the result that the mat 6 and the force-transmitting ply 14 can in particular counteract a deformation 5, deflection or warpage of the plastic part 2 upwards.

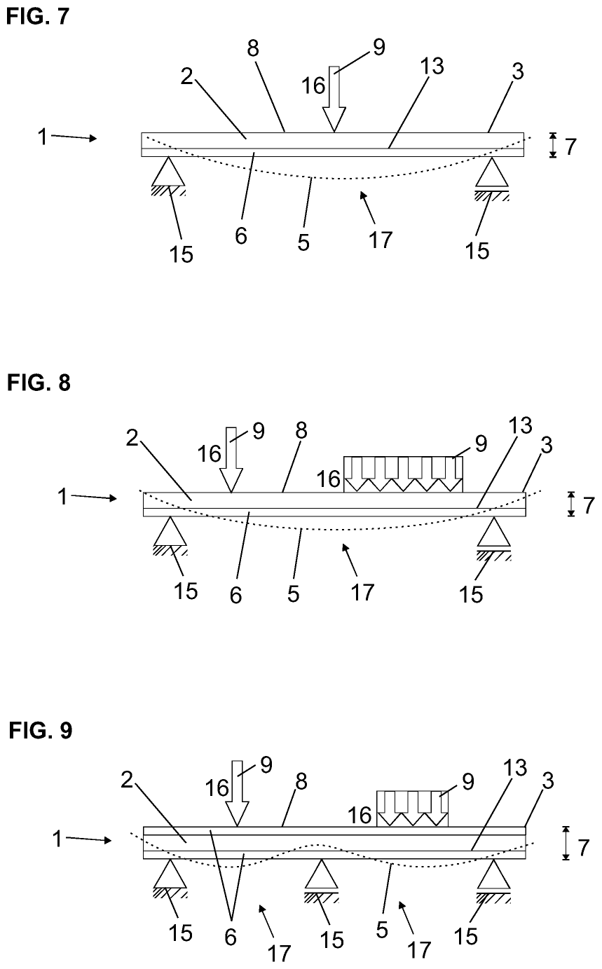

FIGS. 6 and 7 show two representations of a possible arrangement with the first embodiment of a composite part 1, wherein FIG. 6 represents a perspective view and FIG. 7 represents a side view.

In this preferred variant of an arrangement the composite part 1 is arranged in a balanced state by means of two bearing points 15 arranged spaced apart from each other by means of a cavity 17.

In this embodiment the force-application surface 8 is spaced apart from the at least one outer contour area 4 of the outer contour 3 by a thickness 7 of the plastic part 2, wherein the plastic part 2 is, in particular substantially elastically, deformable through the action of an external force 9 on the force-application surface 8.

In this embodiment the mat 6 is arranged on the underside of the plastic part 2, with the result that the mat 6 can counteract a compressive force or external force 9 applied to the upper side with a downwardly directed force-application direction 16 and the deformation 5 thereby occurring downwards.

FIGS. 8-11 show further possible arrangements with different embodiments of a composite part 1.

FIG. 8 shows an arrangement in which the composite part 1 is mounted in the same way as in the variant shown in FIGS. 8 and 7 and wherein a mat 6 is arranged along the entire underside of the plastic part 2.

In this embodiment a concentrated load and a distributed load are applied as external forces 9 to the force-application surface 8 of the composite part 1 or the outer contour 3.

FIG. 9 shows an arrangement in which an embodiment of a composite part 1 is mounted by means of three bearing points 15, wherein two cavities 17 are present between the bearing points 15.

In the case of this composite part 1, a mat 6 is arranged along the entire surface or in the entire outer contour area 4 in each case both on the upper side and/or force-application surface 8 and on the underside of the plastic part 2.

A concentrated load and a distributed load are applied as external forces 9 to the spans over the two cavities 17, wherein the composite part 1 has the deformation 5 represented qualitatively. This deformation 5 specifically present in this case causes tensile loads or stresses on the upper side of the plastic part 2 over the central bearing point 15 and on the undersides of the plastic part 2 substantially centrally in the two spans over the two cavities 17. Here, both mats 6 counteract the deformation 5 of the composite part 1.

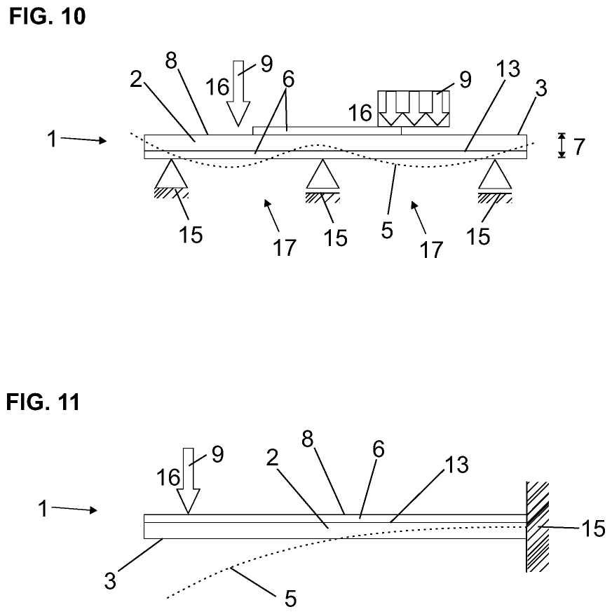

FIG. 10 shows an arrangement in which the composite part 1 has the same bearing as shown in FIG. 9 and is loaded identically by external forces 9. In this embodiment, however, the upper mat 6 is arranged on the upper side and/or force-application surface 8 of the plastic part 2 only locally over the central bearing point 15. This means that the mat 6 is at least partially connected to the plastic part 2 in a force-transmitting manner only in that outer contour area 4 of the plastic part 2 where tensile loads or stresses occur as planned.

FIG. 11 shows an arrangement in which a composite part 1 is mounted on a single bearing point 15 such that the composite part 1 is clamped in a translationally and rotationally immobile manner. The composite part 1 here thus acts conceptually corresponding to a cantilever arm, which warps or deforms in one direction under a load due to an external force 9.

In this embodiment of an arrangement and of a composite part 1 the composite part 1 deforms substantially in the direction of a force-application direction 16 of a concentrated load or external force 9 downwards. In this embodiment the mat 6 is arranged on the upper side and/or force-application surface 8 of the plastic, with the result that it absorbs the tensile stresses occurring due to the deformation 5 and counteracts the deformation 5.

In principle, many further arrangements and formations of the composite part are possible. The composite part can be formed such that it can be exposed optimally to a predetermined arrangement, bearing, load, with the result that the load-bearing capacity can be high and/or the deformation can be small.

1. A composite part comprising a load-bearing plastic part with an outer contour, wherein the outer contour has at least one outer contour area which, in the case of a deformation of the plastic part, can be exposed to a tensile load, wherein at least one mat is arranged at least in the outer contour area, wherein the mat is connected at least in areas to the outer contour area in a force-transmitting manner and is formed to absorb the tensile load occurring due to the deformation and thus to counteract the deformation of the plastic part.

2. The composite part according to claim 1, wherein the outer contour has at least one force-application surface spaced apart from the at least one outer contour area, preferably by a thickness of the plastic part, wherein the plastic part is, in particular substantially elastically, deformable through the action of an external force on the force-application surface.

3. The composite part according to claim 1, wherein the plastic part is formed with a strutting with, in particular regularly arranged, struts and/or as a grating and/or at least in areas has a border, preferably a border of a strutting and/or of a grating.

4. The composite part according to claim 1, wherein the at least one mat is completely connected to the outer contour area of the plastic part in a force-transmitting manner.

5. The composite part according to claim 1, wherein the force-transmitting connection between the mat and the plastic part is produced in a material-bonding, in particular chemically and/or thermally material-bonding, manner and/or in a positive-locking and/or non-positive-locking manner, for example by means of welding, adhesive bonding, vulcanizing, laminating, coating, overmolding and/or by means of embedding.

6. The composite part according to claim 1, wherein the plastic part:
is a shaped part produced by means of a shaping method, in particular an injection-molding part or continuous-casting profile, and/or
consists at least of at least one thermoplastic, in particular amorphous or partially crystalline, and/or technical and/or biobased plastic and/or has a wood portion, and/or
consists at least partially of at least one filler, such as e.g. glass fibers, glass beads, impact modifier etc., in particular wherein the portion of the total of all fillers is greater than 3%, preferably greater than 8%, particularly preferably greater than 10%, of a total volume and/or a total mass of the plastic part.

7. The composite part according to claim 1, wherein the mat consists partially of fibers, in particular comprising aramid, glass, carbon and/or basalt fibers, preferably wherein the fibers are contained in the mat as loose fibers and/or in the form of at least one woven fabric, non-crimp fabric or the like.

8. The composite part according to claim 1, wherein the mat consists at least of at least one resin and/or can be connected to a resin, in particular wherein the resin is an epoxy resin and/or polyester resin, preferably polyurethane resin.

9. The composite part according to claim 1, wherein the outer contour has a smooth and/or rough and/or structured surface texture at least in areas.

10. The composite part according to claim 1, wherein the plastic part has a substantially plate-shaped outer contour with flat outer contour surfaces and/or a curved outer contour with curved outer contour surfaces, preferably wherein at least in each case two of the flat outer contour surfaces and/or of the curved outer contour surfaces are arranged substantially parallel to each other.

11. The composite part according to claim 1, wherein the outer contour has at least one force-transmitting ply, which is connected at least in areas to the outer contour in a force-transmitting manner, preferably which is formed as a plate formed to absorb compressive forces.

12. The composite part according to claim 1, wherein the at least one mat is arranged solely at the outer contour area.

13. A arrangement with at least one bearing point, by which the composite part according to claim 1 is or can be mounted in a stable balanced state, wherein the composite part can be loaded by an external force and is, in particular substantially elastically, deformable at least in the direction of a force-application direction.

14. The arrangement according to claim 13, wherein at least two bearing points are spaced apart from each other, wherein the at least one composite part is mounted by means of the bearing points, preferably wherein the at least two bearing points are spaced apart from each other by at least one cavity, and wherein the at least one outer contour area of the at least one composite part faces the at least one cavity.

15. A method for producing a composite part according to claim 1, comprising:
at least one plastic part is provided, preferably by a shaping process, in particular by injection molding or continuous casting, and at least one mat is provided,
the at least one mat is connected at least in areas to the outer contour area of the plastic part in a force-transmitting manner, in particular in a material-bonding and/or positive-locking manner, in particular by means of welding, adhesive bonding, vulcanizing, laminating, coating and/or by means of embedding.

16. The method according to claim 15,
wherein the at least one plastic part is produced by means of a shaping method, in particular an injection-molding or continuous-casting method, and/or
wherein at least one resin, in particular epoxy resin, is applied to the mat, in particular by means of laminating.
